(19) United States
(12) Patent Application Publication
(10) Pub. No.: US 2012/0213995 A1
(43) Pub. Date: Aug. 23, 2012

(54) Flexible Zn2SnO4/MnO2 Core/Shell Nanocable - Carbon Microfiber Hybrid Composites for High Performance Supercapacitor Electrodes

(75) Inventor: Xiaodong Li, Irmo, SC (US)

(73) Assignee: UNIVERSITY OF SOUTH CAROLINA, Columbia, SC (US)

(21) Appl. No.: 13/401,987

(22) Filed: Feb. 22, 2012

Related U.S. Application Data
(60) Provisional application No. 61/463,709, filed on Feb. 22, 2011.

(51) Int. Cl. D01F 11/12; B01J 21/18; B05D 5/12; D01F 8/18; B82Y 30/00; B82Y 40/00

(52) U.S. Cl. 428/367; 427/118; 428/378; 502/1; 977/883; 977/762

(57) ABSTRACT

Methods for forming hybrid nanowires are provided via forming a plurality of conductive nanowires extending radially from a surface of a flexible microwire; and then forming a thin film shell layer around the conductive nanowires. The conductive nanowires can include a metal oxide, and the thin film shell layer can include a transition metal oxide. Prior to forming the plurality of conductive nanowires, a catalyst coating layer can be formed on the surface of the carbon microfiber. Hybrid structures are also provided, which can include a flexible microwire defining a surface; a plurality of conductive nanowires extending radially from the surface of the flexible microfiber; and a thin film shell layer surrounding each conductive nanowire.

### PRIORITY INFORMATION

The present application claims priority to U.S. Provisional Patent Application Ser. No. 61/463,709 titled “Flexible Zn₂SnO₄/MnO₂ Core/Shell Nanocable-Carbon Microfiber Hybrid Composites for Energy Systems” of Xiaodong Li filed on Feb. 22, 2011, the disclosure of which is incorporated by reference herein.

### GOVERNMENT SUPPORT CLAUSE

This invention was made with government support under W911NF-07-1-0320 awarded by U.S. Army Research Office and under CMMI-0653651 and CMMI 0968843 awarded by the National Science Foundation. The government has certain rights in the invention.

### BACKGROUND

To meet urgent needs for sustainable and renewable power sources in modern electronic industry, many efforts have been made in developing flexible, lightweight and environmentally friendly energy storage devices, such as supercapacitors and batteries. Supereapacitors, also called ultracapacitors, electrochemical capacitors (ECs), or electrical double layer capacitors (EDLCs), have become some of the most promising candidates for next-generation power devices because of their high power density, fast charging/discharging rate, sustainable cycling life (millions of cycles), and excellent cycle stability. Carboneous materials, such as carbon nanotube networks, graphene nanosheets, conducting polymers, transition-metal oxides, and hybrid composites have been used to fabricate flexible supercapacitor electrodes. Among these candidated electrode materials, MnO₂ exhibits many intriguing characteristics, such as low cost, environmental friendness, and natural abundance, suggesting it as the most promising electrode material for next generation supercapacitors.

The theoretical specific capacitance of MnO₂ is 1370 F/g. However, due to its poor electric conductivity (10⁻⁵-10⁻⁶ S/cm) such high theorectical capacitance has not been achieved in experiments. Some high performance results have been reported only from nanometer-thick MnO₂ thin films and/or nanosized MnO₂ particles. In addition, when the loading of MnO₂ is in a high weight percentage in the electrode, the MnO₂ is densely packed and thus has only very limited accessible surface area for participating electrochemical charge storage process, which remarkabley increases the contact resistance and in turn decreases the specific capacitance.

One promising approach to realizing the practical application of MnO₂ and improving its electrical conductivity is to incorporate MnO₂ nanostructures or nanometer-thick thin films into carbon-based materials, such as carbon nanotube networks, graphene sheets, and conductive polymers. Recently, Km et at. demonstrated an improved electrochemical capacitive behavior by coating MnO₂ onto SnO₂ nanowires grown on stainless steel substrate, neverthless, the inflexible/rigid nature of stainless steel substrate prevents them from practical applications in harsh environments such as folding/twisting conditions.

Therfore, a need exists for methods and materials that can maximize utilization of the pseudocapacity of MnO₂, while keeping its thin film morphology and providing reliable electrical connection when designing high performance electrodes for MnO₂-based electrochemical supercapacitors.

### SUMMARY

Objects and advantages of the invention will be set forth in part in the following description, or may be obvious from the description, or may be learned through practice of the invention.

Methods are generally provided for forming hybrid nanowires. For example, a plurality of conductive nanowires can be formed to extend radially from a surface of a flexible microwire (e.g., a carbon microwire). The conductive nanowires can generally include a metal oxide (e.g., Zn₂SnO₄, ZnO, SnO₂, In₂O₃, indium tin oxide, or combinations thereof). Then, a thin film shell layer can be formed around the conductive nanowires. The thin film shell layer can generally include a transition metal oxide (e.g., MnO₂).

In certain embodiments, prior to forming the plurality of conductive nanowires extending radially from the surface of the flexible substrate, a catalyst coating layer can be formed on the surface of the carbon microfiber. For example, the catalyst coating layer can include gold.

Forming the thin film shell layer around the conductive nanowires can be achieved, in one embodiment, via forming a precusor solution comprising Na₂SO₄ and KMnO₄; and then immersing the conductive nanowires into the precursor solution.

Hybrid structures are also generally provided. For example, the hybrid structure can include a flexible microwire (e.g., a carbon microwire) defining a surface; a plurality of conductive nanowires extending radially from the surface of the flexible microfiber; and a thin film shell layer surrounding each conductive nanowire. As with the methods discussed above, the conductive nanowires can include a metal oxide (e.g., Zn₂SnO₄, ZnO, SnO₂, In₂O₃, indium tin oxide, or combinations thereof), and the thin film shell layer can include a transition metal oxide (e.g., MnO₂). In one particular embodiment, a catalyst coating layer (e.g., gold) can be present on the surface of the carbon microfiber.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 shows the structural characterization of an exemplary MnO₂/ZTO/CMF hybrid composite: (a, b, c, d) SEM images of ZTO nanowires grown radially on the woven CMFs; (e) TEM image of a MnO₂ coated ZTO nanowire; (f) Corresponding SAED pattern; (g) HRTEM image of an individual ZTO/MnO₂ nanocable, showing that the rough and thin amorphous layer on the surface of the nanowire is amorphous MnO₂ shell, inset is the corresponding FFT pattern; (h) Lattice-resolved HRTEM image of the ZTO/MnO₂ core/shell nanocable, showing the detailed interface of crystalline ZTO core and amorphous MnO2 shell; (i, j) TEM image and line-scan profiles (indicated by a line in panel i) of the ZTO/MnO₂ core/shell nanocable, showing Zn, Sn, O and Mn elemental profiles; (k) A representative EDS spectrum taken on the nanowire. Scale bars in (a)-(d), (e) , (g), (h) and (i) are 1 mm, 50 μm, 100 μm, 20 μm, 200 nm, 10 nm, 5 nm and 200 nm, respectively.

FIG. 2 shows: (a, b, c) Cyclic votalmmetry (CV) curves of the MnO₂/ZTO/CMF, MnO₂/CMF, and ZTO/CMF composites at different scan rates in 1 M Na₂SO₄ aqueous solution, respectively, showing the high electrochemical performance of the MnO₂/ZTO/CMF hybrid composite in comparison with that of MnO₂/CMF and ZTO/CMF composites. (d) Specific capacitances of the MnO₂/ZTO/CMF (blue), MnO₂/CMF (red), and ZTO/CMF (black) composites at different scan rates derived from cyclic votalmmetry.

FIG. 3 shows: Galvanostatic (GV) constant-current charge/discharge performance of MnO₂/ZTO/CMF hybrid composite electrode. (a) Constant-current charge/discharge curves of the MnO₂/ZTO/CMF hybrid composite electrode at different current densities. (b) Specific capacitances of of the MnO₂/ZTO/CMF hybrid composite at different current densities. (c) Ragone plot of the estimated specific energy and specific power at various charge/discharge rates (current densities). (d) Charge/discharge cycling test at the current density of 10 A/g, showing 1.2% loss after 1000 cycles and inset are the galvanostatic charge/discharge cyclic curves of the first and last 10 cycles.

FIG. 4 shows: (a) Nyquist plot of the electrochemical impedance spectra (EIS) of MnO₂/ZTO/CMF (black squares), MnO₂/CMF (red circles), and ZTO/CMF (blue triangles) composites based on the inset equivalent circuit models. (b) The equivalent circuit diagram of different elements from the EIS analysis.

FIG. 5 shows a general schematic of an exemplary flexible microwire having a plurality of conductive nanowires extending radially from its surface.

FIG. 6 shows a general schematic of a hybrid structure having a thin film shell layer surrounding each conductive nanowire extending radially from a surface of a flexible microwire.

### DETAILED DESCRIPTION OF INVENTION

The following description and other modifications and variations to the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the following description is by way of example only, and is not intended to limit the invention.

In the present disclosure, when a layer is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of since the relative position above or below depends upon the orientation of the viewer.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

As used herein, the prefix “nano” refers to the nanometer scale (e.g., from about 1 um to about 999 nm). For example, wires having an average diameter on the nanometer scale (e.g., from about 1 nm to about 999 nm) are referred to as “nanowires”. On the other hand, wires having an average diameter of greater than 1,000 nm (i.e., 1 μm) are generally referred to as “microwires”, since the micrometer scale generally involves those materials having an average size of greater than 1 μm.

Methods are generally provided for the design and fabrication of a hybrid nano/micro-architecture by facile coating ultra-thin (several nanometers thick) MnO₂ films to highly electrical conductive metal oxide (e.g., ZTO) nanowires grown radially on flexible microfibers (e.g., carbon microfibers) to achieve high specific capacitance, high energy density, high power density, and long-term life for supercapacitor electrode applications. Such hybrid composites with hierarchical architecture are very promising for next generation high performance flexible supercapacitors.

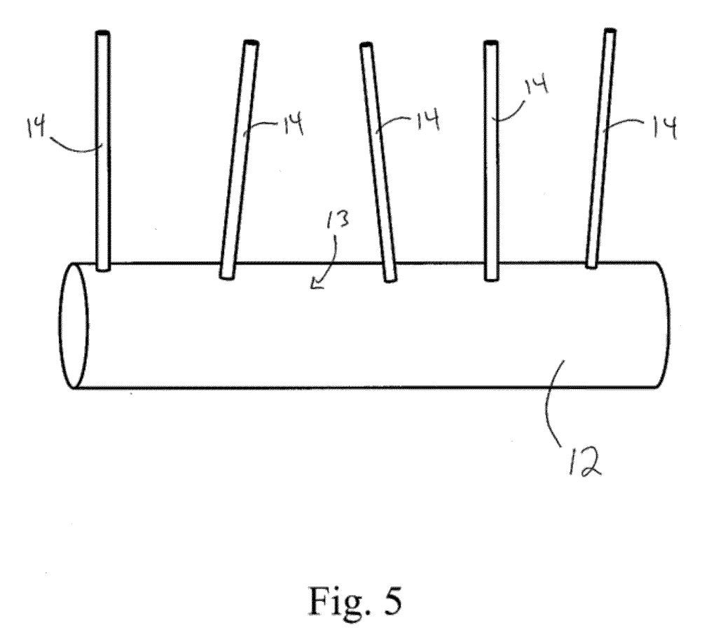

Referring to FIG. 5, an exemplary schematic is generally shown of a flexible microfiber 12 having a plurality of conductive nanowires 14 grown radially from its surface 13. As shown, each of the conductive nanowires 14 generally extends in a direction away from the surface 13 of the flexible microfiber 12 to define an individual conductive nanowire. In one particular embodiment, each conductive nanowire 14 can include a metal oxide, such as a zinc tin oxide (“ZTO”). Additionally, the surface 13 of the flexible microfibers 12 can have a catalyst coating layer (e.g., gold) that can serve as a catalyst seed for the formation of the conductive nanowires 14 extending from the flexible microfibers 12.

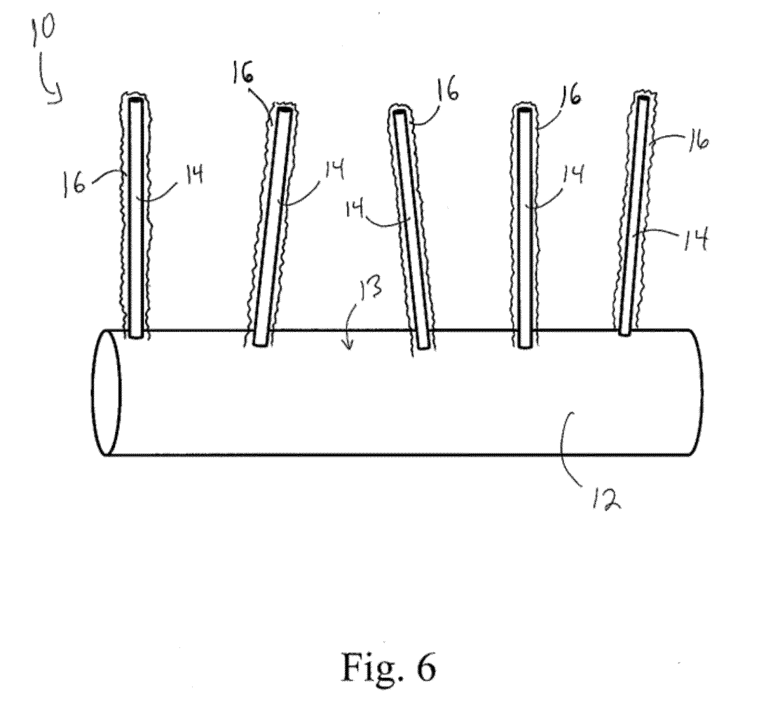

FIG. 6 shows an exemplary schematic of a hybrid structure 10 having a plurality of conductive nanowires 14 grown radially on the surface 13 of the carbon microfiber 12, as in FIG. 5, where a shell thin film layer 16 has been formed around each conductive nanowire 14. In one particular embodiment, the shell thin film layer 16 generally includes a transition metal oxide, such as MnO₂.

In one particular embodiment, the crystalline ZTO nanowires grown radially on CMFs can serve as highly conductive cores to support the redox ative MnO₂ shells wth highly electrolytic accessible surface areas and to provide reliable electrical connections to the MnO₂ shells.

Each of the flexible microfibers 12, the conductive nanowires 14, and the thin film shell layer 16 are discussed in greater detail below.

I. Flexible Microfibers

Any suitable flexible microfiber can serve as the flexible substrates for synthesizing metal oxide conductive nanowires, particularly with assistance of catalyst coating layer present on its surface. In one particular embodiment, the flexible microfiber can generally be a carbon microfiber, such as those generally composed mostly of carbon atoms, with hydrogen and nitrogen atoms sometimes present. The carbon atoms are generally bonded together in crystals that are aligned substantially parallel to the long axis of the microfiber. In one particular embodiment, each carbon microfiber diameter of about 5 micrometers (μm) to about 20 μm, such as about 5 μm to about 8 μm.

Such carbon microfibers can be produced from a precursor polymer. For example, the precursor polymer can be rayon, polyacrylonitrile (PAN), petroleum pitch, etc. Typicallly, for synthetic polymers such as rayon or PAN, the precursor is first spun into filaments, using chemical and mechanical processes to initially align the polymer atoms in a way to enhance the final physical properties of the completed carbon fiber. Precursor compositions and mechanical processes used during spinning may vary among manufacturers. After drawing or spinning, the polymer fibers can then be heated to drive off non-carbon atoms (carbonization), producing the final carbon fiber. The atomic structure of carbon microfiber is generally similar to that of graphite, with sheets of carbon atoms (graphene sheets) arranged in a regular hexagonal pattern.

The crystal alignment gives the microfiber high strength-to-volume ratio (e.g., it is strong for its size). The properties of such carbon microfibers, such as high flexibility, high tensile strength, low weight, high resistance, high temperature tolerance and low thermal expansion, make them very popular in aerospace, civil engineering, military, and motorsports, along with other competition sports. Such carbon microfibers are well known in the art and are readily available commercially.

Other suitable flexible microfibers may also be used. For example, the flexible microfiber can be a metal microfiber having a sufficient degree of flex, and defining a thin film catalyst coating layer on its surface.

As stated, the surface of the flexible microfiber may define a catalyst coating layer formed thereon. The catalyst coating layer can serve as a catalyst and seed for the formation of the conductive nanowires to be grown radially thereon. Suitable materials that can be present in the catalyst coating layer can include Au, Fe, Ni, Ag, Co, or combinations thereof. In one embodiment, the catalyst coating layer can include gold (Au). For example, the catalyst coating layer can, in one particular embodiment, consist essentially of gold (i.e., substantially free from other metals).

The catalyst coating layer can be present on the surface of the flexible microfibers to an average thickness of about 5 nm to about 100 nm on the surface of the flexible microwire. This catalyst coating layer can be fabricated via any technique, such as those discussed below with respect to the metal oxide conductive layer.

II. Conductive Nanowires

According to the present invention, a plurality of conductive nanowires can be formed (e.g., grown) radially around the flexible microwire. The conductive nanowires are generally composed of at least one metal oxide. In certain embodiments, for example, the metal oxide included in the conductive nanowires can generally be Zn₂SnO₄ (ZTO), ZnO, SnO₂, In₂O₃, indium tin oxide (ITO), or combinations thereof. In one particular embodiment, the metal oxide can include Zn₂SnO₄. For instance, the conductive nanowires can consist essentially of ZTO (e.g., consist of ZTO).

The conductive nanowires can be formed according to any suitable method, such as a vapor transport method, physical deposition methods (e.g., sputtering), chemical vapor deposition methods, etc.

In one embodiment, for example, a vapor transport method can be used to form the conductive nanowires around the carbon microwire. In such a method, for instance, Zn and SnO powders can be mixed, ground, and loaded into a furnace. The microfiber (e.g., coated with a metal thin film, such as gold) loaded into the furnace. The furnace can then be heated (e.g., to a deposition temperature of about 800° C. to about 1000° C., such as about 850° C. to about 950° C.). For example, the furnace can be heated at a rate of about 3° C./min to about 10° C./min. Then, once at the deposition temperature, the furnace can be held constant for at least 30 minutes to synthesize the ZTO nanowires. During deposition, an inert gas (e.g., Ar gas) can be introduced into the furnace (e.g., at a flow rate of about 50 sccm), and the deposition pressure can be kept relatively low (e.g., less than about 10 Torr, such as about 1 Torr to about 8 Ton).

The conductive nanowires can, in certain embodiments, have an average diameter of about 10 nm to about 100 nm, such as about 15 nm to about 50 nm. Additionally, the conductive nanowires can, in certain embodiments, extend for a length of about 1 μm to about 20 μm.

III. Thin Film Shell Layer

A thin film shell layer can be formed over (e.g., surrounding) the conductive nanowires. The thin film shell layer generally includes at least one transition metal oxide, but may also include other materials. In certain embodiments, for example, the transition metal oxide included in the thin film shell layer can generally be MnO₂, V₆O₁₃, V₂O₅, WO₃, MoO₃, RuO₂, Fe₃O₄, or combinations thereof.

In one particular embodiment, the transition metal oxide can include MnO₂. For example, the thin film shell layer can include MnO₂ in at least about 90% by weight of the thin film shell layer, such as about 95% by weight to 100% by weight. For example, the thin film shell layer can, in certain embodiments, consist essentially of MnO₂ such that the thin film shell layer generally is substantially free from other materials.

The thin film shell layer can be formed on the conductive nanowires according to any suitable method, such as a spontaneous redox deposition, physical deposition methods (e.g., sputtering), chemical vapor deposition methods, etc.

In one embodiment, for example, a spontaneous redox deposition method can be used to form the thin film shell layer around the conductive nanowires. For example, in such a method, a precursor solution for the coating process can be prepared by mixing Na₂SO₄ and KMnO₄ solutions. Conductive nanowires, together with their supporting flexible microwires, can then be immersed into the precursor solution for a sufficient time to allow the thin film shell layer comprising MnO₂ to be formed thereon. The thickness of the thin film shell layer can be controlled by adjusting the immersion time, which can typically be about 30 minutes to about 120 minutes (e.g., about 60 minutes). After immersing, the resulting coated microfiber can be rinsed with deionized water and then heat treated (e.g., at 120° C. for 12 h) in air.

As such, in most embodiments, the thin film shell layer can cover substantially all of the surface area of the conductive nanowires. For example, the thin film shell layer can cover at least about 95% of the surface area of the conductive nanowires, such as about 97% to 100% of the surface area of the conductive nanowires.

### EXAMPLES

The design and fabrication of a hybrid nano/micro-architecture was demonstrated by facile coating ultra-thin (several nanometers thick) MnO₂ films to highly electrical conductive Zn₂SnO₄ (ZTO) nanowires (conductivity: 10²-10³ S/cm) grown radially on flexible carbon microfibers (CMFs) to achieve high specific capacitance, high energy density, high power density, and long-term life for supercapacitor electrode applications. The maximum specific capacitances of 621.6 F/g (based on pristine MnO₂) by cyclic voltammetry (CV) at a scan rate of 2 mV/s and 642.4 F/g by chronopotenitiometry at a current density of 1 A/g were achieved in 1 M Na₂SO₄ aqueous solution. The MnO₂/ZTO/CMF hybrid composite also exhibited excellent rate capability with a specific energy of 36.8 Wh/kg and a specific power of 32 kW/kg at the current density of 40 A/g, respectively, and outstanding long-term cycling stability (only 1.2% loss of its initial specific capacitance after 1000 cycles). These results suggest that such MnO₂/ZTO/CMF hybrid composite with hierarchical architecture is very promising for next generation high performance flexible supercapacitors.

The crystalline ZTO nanowires grown radially on CMFs served uniquely as highly electrical conductive cores to support the redox active MnO₂ shells with highly electrolytic accessible surface areas and to provide reliable electrical connections to the MnO₂ shells, enabling full utilization of MnO₂ and realizing fast electric and ionic conduction through the electrode. The maximum specific capacitance of 621.6 F/g (based on pristine MnO₂) by cyclic votalmmetry (CV) at a scan rate of 2 mV/s and 642.4 F/g by chronopotenitiometry at a current density of 1 A/g were achieved in 1 M Na₂SO₄ aqueous solution. The MnO₂/ZTO/CMF hybrid composite also exhibited excellent rate capability with a specific energy of 36.8 Wh/kg and a specific power of 32 kW/kg at the current density of 40 A/g, and outstanding long-term cycling stability (only 1.2% loss of its initial specific capacitance after 1000 cycles), which were derived from galvanostatic (GV) charge-discharge measurements. These results suggest that such MnO₂/ZTO/CMF hybrid composite with hierarchical architecture is very promising for next generation high performance flexible supercapacitors,

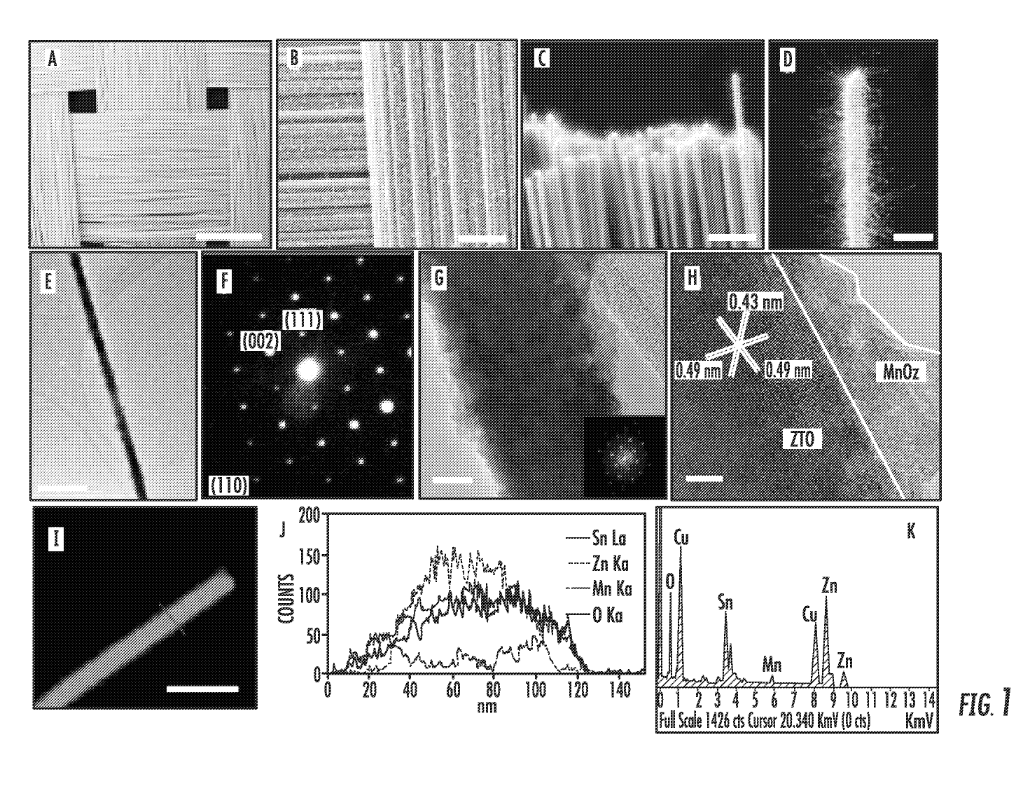

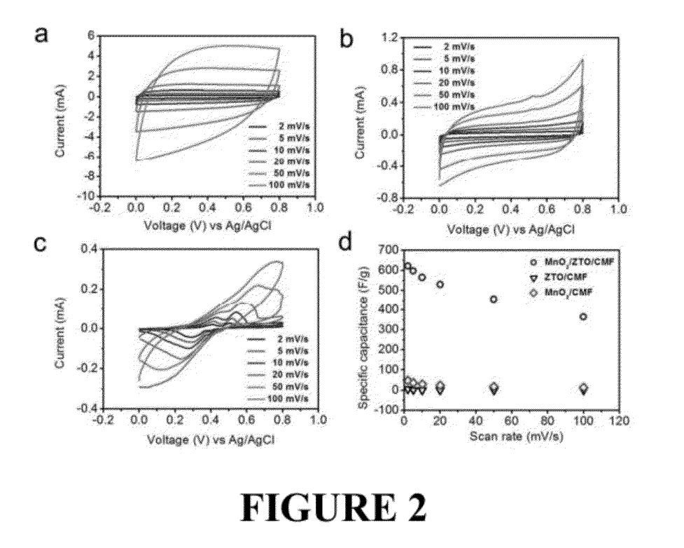

High density ZTO nanowires were fabricated on commercial woven CMFs with a diameter of several micrometers by a simple vapor transport method in a horizontal tube furnace (for details, see Supporting Information). To faciliate the eletrochemical tests, one bundle of ZTO nanowire/CMF were taken out from the woven structures and then immersed into a mixed solution containing 0.1 M Na₂SO₄ (Sigma-Aldrich) and 0.1 M KMnO₄ (Sigma-Aldrich). In addition, to enhance the mechanical stability and electrical conductivity of the electrode, after coating MnO₂, the MnO₂/ZTO/CMF hybrid composite was heat treated at 120° C. for 12 h in air (for details, see Supporting Information). FIG. 1(a-d) shows the morphology and microstructure of ZTO nanowires on the woven CMFs. It is revealed that high density of ZTO nanowires were radially grown on the CMFs. These ZTO nanowires have lengths of tens of micrometers and diameters of around 80 nm. To investigate the microstructure of ZTO/MnO₂ core/shell nanocables, TEM imaging and selected-area electron diffraciton (SAED) analysis were employed. A typical TEM image of an individual nanocable is shown in FIG. 1e. The SAED pattern (FIG. 1f) can be indexed as single crystalline inverse spinel structure of Zn₂SnO₄ with [110] as zone axis (JCPDS No. 24-1470, Fd 3̅m, a=b=c=0.865 nm). No MnO₂ related diffraction pattern or spot can be found, indicating that the coated MnO₂ is amorphous. A rough and amorphous MnO₂ shell with a thickness of several nanometers was found on the ZTO nanowire surface, as shown in FIGS. 2g and 2h. The elemental spatial distributions across the ZTO/MnO₂ core-shell nanocale were characterized by energy-dispersive spectroscopy (EDS) in the form of line scan profiles of individual elements Zn, Sn, O and Mn, as shown in FIG. 2j. The peaks of the Zn and Sn line-scan profiles are located in the center of the profile of Mn, confirming the core-shell configuration of the ZTO/MnO₂ nanocable. The oxidation state of Mn atoms in the as-coated MnO₂ shells on ZTO nanowire cores was determined as ˜4.0 by X-ray photoelectron spectroscopy (XPS) (for details, see Supporting Information). The amorphous nature of the MnO₂ coating is more favorable for supercapacitor applications compared with the previously reported crystalline MnO₂ coatings.⁴² This core-shell ZTO/MnO₂ architecture has a potential to improve the electrochemical performance of the MnO₂/ZTO/CMF hybrid composite. The thin layer of MnO₂ enables the fast and reversible faradic reaction by shortening the ion diffusion path and such a low weight loading of MnO₂ can achieve high specific capacitance. Furthermore, the high specific areas of core ZTO nanowires provides highly conductive channels to effectively transport electrolyte. By using this nano/micro hierarchical design, we can fully utilize the outstanding electrochemical performance of MnO₂ to realize both high energy densty and high power density characteristics for real electrochemical capacitor applications.

FIG. 2a shows the cyclic votalmmetry (CV) curves of the MnO₂/ZTO/CMF hybrid composite electrode at scan rates of 2, 5, 10, 20, 50, 100 mV/s with potential windows ranging from 0 to 0.8V vs Ag/AgCl in 1 M Na₂SO₄ aqueous solution. The shapes of these curves are quasi-rectangular, indicating the ideal electrical double-layer capacitance behavior and fast charging/discharging process characteristic. The MnO₂ coated ZTO nanowires involved redox reactions in the cyclic voltammetry tests as the Mn atoms in the overlayer were converted into higher/lower valence states, which were induced by intercalation/extration of protons (H₃O⁺) or alkili cations (Na⁺) into/out of the ZTO/MnO₂ core/shell nanocables and could be expressed as:

MnO₂+M⁺+e⁻ [symbol] MnOOM, M⁺=Na⁺ or H₃O⁺ (1)

To demonstrate the electrochemical performance benefits of the MnO₂/ZTO/CMF hybrid composite, cyclic votalmmetry (CV) tests were performed on the respective MnO₂/CMF and ZTO/CMF composites, as shown in FIGS. 2b and 2c. For the MnO₂/CMF composite (FIG. 2b), the CV curves obtained at different scan rates also show quasi-rectangular shapes, however, the separation between leveled anodic and cathodic currents are much smaller than the MnO₂/ZTO/CMF composite at the same scan rates, indicating smaller specific capacitances for the MnO₂/CMF and ZTO/CMF composites. For the ZTO/CMF composite (FIG. 2c), the CV curves do not show the normal regular shape and the leveled current separation between leveled anodic and cathodic currents are much smaller, suggesting the poor electrochemical performance of the ZTO/CMF composite. The specific capacitances calculated from the CV curves (for details, see Supporting Information) with different scan rates are shown in FIG. 2d. At the scan rate of 2 mV/s, the specific capacitance of the MnO₂/ZTO/CMF hybrid composite can achieve 621.6 F/g (based on the mass of pristine MnO₂), while those of the MnO₂/CMF and ZTO/CMF composites are only 46.6 and 5.6 F/g, respectively. The CV tests performed on the CMF electrode indicated that only 0.15 F/g of specific capacitance can be obtained at the scan rate of 2 mV/s (for details, see Supporting Information). Therefore, in the MnO₂/ZTO/CMF hybrid composite, the capacitance contributed from ZTO nanowires and CMFs are negligible. The CV tests suggest that compared with the MnO₂/CMF composite, through growth of ZTO nanowires on CMFs as template to coat MnO₂, the electrochemical accessible surface area is remarkably increased due to the large surface to volume ratio of the ZTO nanowires, resulting in the significant improvement of the specific capacitance. Additionally, the high specific capacitance value confirms that such design and fabrication of the MnO₂/ZTO/CMF hybrid composite allows maximizing the utilization of the electrochemical performance of MnO₂.

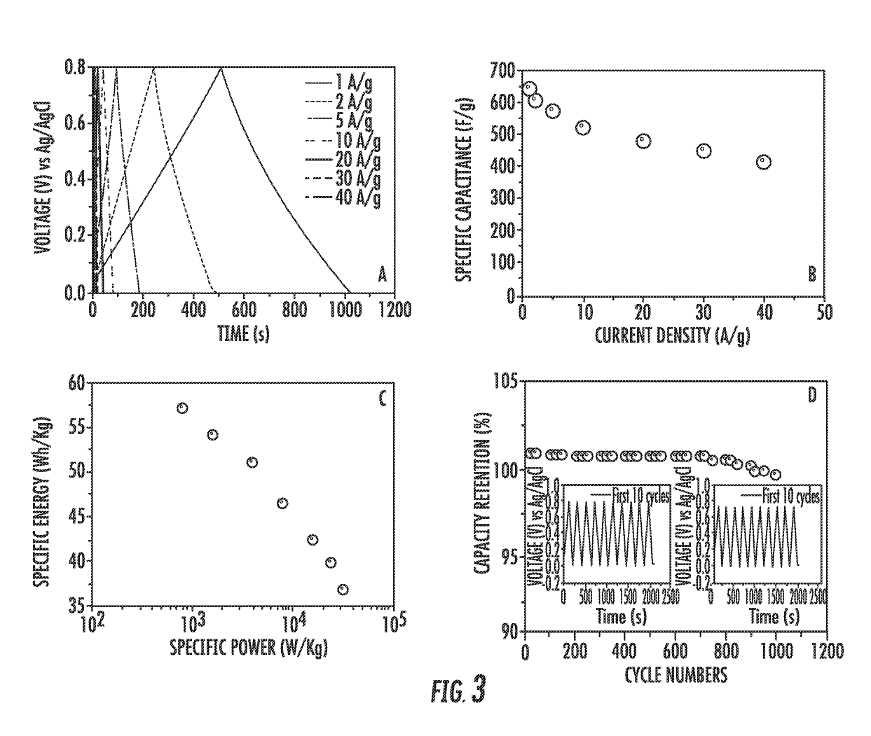

Rate capabilitiy is one of the important factors for evaluating the power applications of supercapacitors. The constant-current galvanostatic (GV) charge/discharge curves of the as-prepared MnO₂/ZTO/CMF hybrid composite at different current densities are shown in FIG. 3a. The charging/discharging cycling curves have a vey symmetric nature, indicating again that the composite has a good electrochemical capacitive characteristic and superior reversible redox reaction. This symmetric nature of the charing/discharging cycling curves can be maintained even at a low density of 1 A/g, as shown in FIG. 3 a. The specfic capacitances derived from the discharging curves (for details, see Supporting information) at different charge/discharge rates (current densities) are shown in FIG. 3b. The specfic capacitance of the composite at the current density of 1 A/g was calculated to be 642.3 F/g based on the mass of the pristine MnO₂, which is comparable with the results of the CV tests. Although the specific capacitance is lower than the previously reported 800 F/g, our prepared MnO₂/ZTO/CMF hybrid composite electrode is highly flexible and lightweight and can be applied even in harsh environments such as folding/twisting conditions. To study the flexibility of the composite electrodes, we investigated the electrochemical performance of the MnO₂/ZTO/CMF hybrid composite electrodes under folding/twisting conditions, no apparent changes were observed in the electrochemical tests. This confirms the highly flexible nature of the MnO₂/ZTO/CMF hybrid composite electrodes for supercapacitors. At a very high current density of 40 A/g, the specific capacitance remained at 413.9 F/g. Such superior rate capability in the MnO₂/ZTO/CMF hybrid composite can be attributed to the reduced short diffusion path of ions, highly accessible surface area and increased electrical conductivity by utilizing ZTO nanowires radially grown on CMFs as supporting backbones to coat MnO₂.

Specific energy and specific power are the two key factors for evaluating the power applications of electrochemical supercapacitors. A good electrochemical supercapacitor is expected to provide both high energy density and high specific capacitance at high charging-discharging rates (current densities). FIG. 3c shows the Ragone plot for the MnO₂/ZTO/CMF composite electrode at the potential window of 0.8 V in 1 M Na₂SO₄ aqueous solution. The specific energy decreases from 57.1 to 36.8 Wh/kg, while the specific power increases from 0.8 to 32 kW/kg as the galvanostatic (GV) charge/discharge current increased from 1 to 40 A/g. These values are much higher than those of conventional supercapacitors in Ragone plot. Most importantly, the highest specific power value, 32 kW/kg, can meet the power demands of the PNGV (Partnership for a New Generation of Vehicles), demonsrating the feasiblity of the as-prepared MnO₂/ZTO/CMF hybrid composite electrode for electrochemical supercapacitors as power supply components in hybrid vehicle systems.

Another important requirement for supercapacitor applications is cycling capability or cycling life. The cycling life tests over 1000 cycles for the MnO₂/ZTO/CMF hybrid composite at a current density of 10 A/g were carried out using constant-current galvanostatic (GV) charge/discharge cycling techniques in the potential windows ranging from 0 to 0.8 V. FIG. 3d shows the specific capacitance retention of the MnO₂/ZTO/CMF hybrid composite as a function of charge/discharge cycling numbers. The composite electrode showed only 1.2% loss in the specific capacitance after 1000 charge-discharge cycles and the last 10 cycles remained almost the same shape of charge-discharge curves with the first 10 cycles (insets in FIG. 3d), illustrating the excellent long term cyclability of the composite electrode.

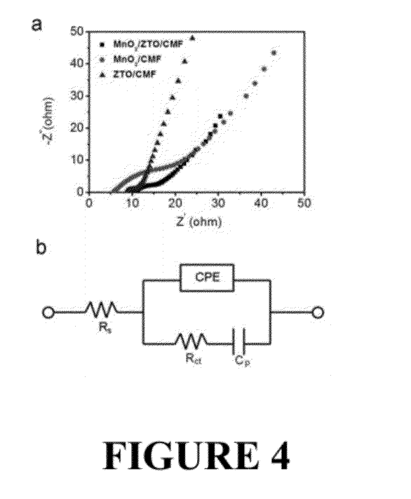

The enhanced electrochemical performance of the hybrid composite electrode with using ZTO nanowires radially grown on CMFs as the template to coat MnO₂ shells was further confirmd by the electrochemical impedance spectroscopy (EIS) measurements in the same setup as the CV and GV tests. FIG. 4a shows the Nyquist plots of the EIS spectra of ZTO/CMF (blue triangles), MnO₂/CMF (red circles) and MnO₂/ZTO/CMF (black squares) composites, respectively. The EIS data can be fitted by a equivalent circuit consisting of a bulk solution resistance R₅, a charge-transfer R_{ct}, a pseudo-capacitive element Cₚ from redox process of MnO₂, and a constant phase element (CPE) to account for the doule-layer capacitance, as shown in FIG. 4b. The bulk solution resistance Rₛ and charge-transfer resistance R_{ct} can be obtained from the Nyquist plots, where the high frequency semicircle intercepts the real axis at Rₛ and (Rₛ+R_{ct}), respectively. The solution resistance Rₛ of these three composites was measured to be 8.7, 5.5 and 10.6Ω, respectively, while the charge-transfer resistance R_{ct} was calculated to be 1.6, 13.4 and 4.9Ω, respectively. This clearly demonstrates the reduced charge-transfer resistance of the MnO₂/ZTO/CMF hybrid composite electrode by using ZTO nanowires radially grown on CMFs as the template to coat MnO₂ thin layers compared with that of using CMFs alone to coat MnO₂ directly. In addition, the charge-transfer resistance R_{ct}, also called Faraday resitance, is a limiting factor for the specific power of the supercapacitor. It is the low Faraday resistance that results in the high specific power of the MnO₂/ZTO/CMF hybrid composite electrode.

In summary, a simple and cost-effective mothodology is developed to fabricate flexible supercapacitors based on MnO₂/ZTO/CMF hybrid composite electrodes. In such a composite, the thin amorphous MnO₂ layer enables fast reversible redox reaction to improve the specific capacitance, while the ZTO nanowires grown radially on CMFs provide highly conductive supporting backbones for coating amorphous MnO₂ to effectively transporting electrolytes and shortening the ion diffusion path. These characteristics offer the excellent electrochemical performance of the MnO₂/ZTO/CMF hybrid composites, such as high specific capacitance, good charge-discharge stability, excellent rate capability, long-term cycling life, high specific energy and high specfic power. These results suggest that such MnO₂/ZTO/CMF composite with hierarchical architecture is very promising for next generation high performance flexible supercapacitors.

### Supporting Information: Fabrication and Characterization of Zn₂SnO₄ Nanowires on Carbon Microfibers

Commercially available woven carbon microfibers (CMFs, Fibre Glast Development Corporation) were used directly as templated substrate without further processing to synthesize Zn₂SnO₄ (ZTO) nanowires. The ZTO nanowires were synthesized via a simple vapor transport method in a horizontal alumina tube furnace (id: 73 mm, length: 1000 mm, GSL-1700-60X, MTI Corp.). Zn and SnO powders (weight ratio 1:2, purchased from Sigma-Aldrich) were mixed, ground, and then loaded into an alumina boat, which was then placed in the center of the alumina tube mounted on the furnace. The CMFs sputter-coated with Au film were placed at 5 cm downstream from the alumina boat. The tube furnace was sealed and heated to 900° C. at a rate of 5° C./min, and then held for 1 h to synthesize ZTO nanowires. During the experiment, high purity Ar gas (99.99%) was introduced into the tube at a flow rate of 50 seem and the pressure of the tube was evacuated to a pressure of 5 Torr. After the furnace was cooled down to the room temperature, the resulting product was collected for characterization by scanning electron microscopy (SEM, Zeiss Ultra Plus FESEM), X-ray diffraction (XRD, Rigaku DMax 2200 using Cu K_{α} radiation, λ=1.5418 Å), X-ray photoelectron spectroscopy (XPS, Kratos Axis Ultra DLD equipped with a monochromated Al K_{α}X-ray source and hemispherical analyzer capable of an energy resolution of 0.5 eV), transmission electron microscopy (TEM, Hitachi H8000) and high-resolution TEM (HRTEM, JEOL 2010F equipped with an EDX detector from Oxford Instruments). To investigate the improvement of the electrochemical performance by using CMFs as substrate, a control sample with ZTO nanowires grown on stainless steel (SS) substrate was similarly fabricated by replacing the CMFs with SS substrate while keeping other experimental conditions the same.

Supporting Information: Coating MnO₂ onto ZTO Nanowires Grown on CMFs

Previous studies have shown that spontaneous redox deposition of MnO₂ on carbon materials is pH-dependent. In acid solutions, reduction of permanganate ion (MnO₄) to MnO₂ can result in large agglomerated particles of MnO₂. While in neutral solutions, thin films of MnO₂ can be obtained on the surface of carbon. In this study, the precursor solution for the coating process was prepared by mixing 0.1 M Na₂SO₄ (Sigma-Aldrich) and 0.1 M KMnO₄ (Sigma-Aldrich) solutions. The CMFs grown with ZTO nanowires were immersed into the solution and the typical duration time of the immersion was 60 min. The loading amount of MnO₂ can be easily controlled by adjusting the immersion time. After immersing, the sample was rinsed with deionized water and then heat treated at 120° C. for 12 h in air. In addition, the control samples of MnO₂/CMF and MnO₂/ZTO/SS composites were fabricated similarly by coating MnO₂ onto commercial CMFs and ZTO nanowires on SS substrate, respectively.

### Supporting Information: Electrochemical Characterization

Electrochemical performance of MnO₂/ZTO/CMF hybrid composite electrode was carried out using a CHI 760D electrochemical workstation (CH Instruments Inc., Texas, USA). The standard three-electrode cell was composed of Ag/AgCl as reference electrode, Pt mesh as counter electrode and the synthesized composite sample as working electrode, respectively. A 1 M Na₂SO₄ solution served as electrolyte at room temperature. Cyclic voltammetry (CV) was performed at various scan rates of 2, 5, 10, 20, 50, and 100 mV S⁻¹. Galvanostatic (GV) charge/discharge curves were obtained at various current densities of 1, 2, 5, 10, 20, 30 and 40 A g⁻¹ to evaluate the specific capacitance. A potential window in the range from 0 to 0.8 V was used in all the measurements. Electrochemical impedance spectra (EIS) were measured in the frequency range from 10000 to 0.1 Hz with 0 V mean voltage and amplitude 5 mV using the same setup as CV and GV tests.

### Supporting Information: Analysis of the Average Manganese Oxidation State in MnO₂/ZTO/CMF Hybrid Composite

X-ray photoelectron spectroscopy (XPS) spectra of the MnO₂/ZTO/CMF hybrid composite were used to determine the oxidation state of as-coated MnO₂ shells on ZTO nanowire cores. Mn 2p spectrum showed that the binding energy peaks of Mn 2p_{3/2} and Mn 2p_{1/2} are centered at 642.2 eV and 654.1 eV, respectively, which is in good agreement with the previously reported peak binding energy separation (11.8 eV) between Mn 2_{3/2} and Mn 2p_{1/2}. As reported previously, the average oxidation state of Mn in manganese oxides can be determined by the separation of peak energies (ΔE) of the Mn 3s peaks caused by multiplet splitting, where the ΔE data of MnO, Mn₃O₄, Mn₂O₃ and MnO₂ are 5.79, 5.50, 5.41 and 4.78 eV, respectively. The as-prepared MnO₂/ZTO/CMF hybrid composite electrode showed a separated energy of 4.7 eV for the Mn 3s doublet, which suggests that the oxidation state of the Mn in the composite is ˜4.0.

### Supporting Information: Cyclic Voltammogrammetry (CV) Test Performed on CMF Control Sample

To evaluate the capacitance contributed from the CMFs in the MnO₂/ZTO/CMF hybrid composite, cyclic voltammogrammetry (CV) test was performed on a CMF control sample. The maximum specific capacitance of the CMF at the scan rate of 2 mV/s derived from CV curve is 0.15 F/g.

### Supporting Information: Galvanostatic (GV) Tests Performed on CMF, ZTO/CMF and MnO₂/CMF Composites

To demonstrate the electrochemical performance benefits of the MnO₂/ZTO/CMF hybrid composite, galvanostatic tests were also performed on respective CMF, ZTO/CMF and MnO₂/CMF composites. The GV constant-current charge/discharge curves of CMF, ZTO/CMF and MnO₂/CMF composites at the current density of 1 A/g were studied.

### Supporting Information: Comparison of the Cyclic Voltammetry (CV) Curves Between MnO₂/ZTO/CMF and MnO₂/ZTO/Stainless Steel (SS) Composites

To demonstrate the electrochemical performance benefits of the higher surface area of CMFs with reference to a flat conductive substrate, the cyclic voltammetry (CV) curves of MnO₂/ZTO/CMF and MnO₂/ZTO/SS composites were compared. The SEM image of MnO₂/ZTO nanocables on SS substrate indicated that high density of MnO₂/ZTO nanocables were grown on the SS substrate. The cyclic voltammetry (CV) curves of the MnO₂/ZTO/SS composite at different scan rates in 1 M Na₂SO₄ aqueous solution were studed. The specific capacitances between the MnO₂/ZTO/Stainless Steel (SS) and MnO₂/ZTO/CMF composites at different scan rates showed that the MnO₂/ZTO/CMF hybrid composite has a higher specific capacitance than the MnO₂/ZTO/SS composite. The MnO₂/ZTO/CMF hybrid composite shows an ideal quasi-rectangular shape, and the area covered by the CV curve of the MnO₂/ZTO/CMF hybrid composite was larger than that of the MnO₂/ZTO/SS composite, suggesting that the MnO₂/ZTO/CMF hybrid composite has a better electrochemical performance than the MnO₂/ZTO/SS composite.

### Supporting Information: Coverage of the ZTO Nanowires on CMF Substrate

As shown in the SEM images of the ZTO nanowires, high density of ZTO nanowires with a full coverage has been grown on the CMFs. The ZTO nanowires covered all around the CMFs, even the space between the CMFs.

### Supporting Information: Flexibility Tests Performed on the MnO₂/ZTO/CMF Hybrid Composite

To demonstrate the flexible nature of the MnO₂/ZTO/CMF hybrid composite as electrode for supercapacitors, the electrochemical performances of the composite under both normal test and bending conditions were compared. The optical photographs of the composite under normal test and bending conditions showed that the cyclic voltammetry curves of the normal test and bending conditions are almost same, and no apparent changes were observed even when the MnO₂/ZTO/CMF composite was mechanically bent to an angle of 60 degrees.

### Calculations

1. Specific capacitances derived from cyclic votalmmetry (CV) tests can be calculated from the equation:

$$C = \frac{1}{mv ( {V}_{c} - {V}_{a} )} {\int }_{{V}_{a}}^{{V}_{c}} I ( V ) d V \qquad ( 1 )$$

where C (F/g), m (g), υ (V/s), V_{c} and Vₐ, and I(A) are the specific capacitance, the mass of the active materials in the electrode, potential scan rate, high and low potential limit of the CV tests, and the instant current on CV curves, respectively.
2. Specific capacitances derived from galvanostatic (GV) tests can be calculated from the equation:

$$C = \frac{I Δ t}{m Δ V} \qquad ( 2 )$$

where C (F/g), I (A), Δt (s), m (g) and ΔV are the specific capacitance, the discharge current, the discharge time, the mass of the active materials in electrode, and the potential window, respectively.
3. Specific energy (E) and specific power (P) derived from GV tests can be calculated from the following equations:

$$\begin{matrix}E = \frac{1}{2} {C ( Δ V )}^{2} & ( 3 ) \\ P = \frac{E}{Δ t} & ( 4 )\end{matrix}$$

where E (Wh/kg), C (F/g), ΔV (V), P (W/kg) and Δt (s) are the specific energy, specific capacitance, potential window, specific power and discharge time, respectively.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. A method of forming hybrid nanowires, the method comprising:
formed a plurality of conductive nanowires extending radially from a surface of a flexible microwire, wherein the conductive nanowires comprise a metal oxide; and
forming a thin film shell layer around the conductive nanowires, wherein the thin film shell layer comprises a transition metal oxide.

2. The method as in claim 1, wherein the transition metal oxide comprises MnO₂.

3. The method as in claim 1, wherein the metal oxide comprises Zn₂SnO₄, ZnO, SnO₂, In₂O₃, indium tin oxide, or combinations thereof.

4. The method as in claim 1, wherein the metal oxide comprises Zn₂SnO₄.

5. The method as in claim 1, further comprising:
prior to forming the plurality of conductive nanowires extending radially from the surface of the flexible substrate, forming a catalyst coating layer on the surface of the carbon microfiber.

6. The method as in claim 5, wherein the catalyst coating layer comprises gold.

7. The method as in claim 1, wherein the conductive nanowires have an average diameter of about 10 nm to about 100 nm.

8. The method as in claim 1, wherein the thin film shell layer has an average thickness of about 1 nm to about 20 nm.

9. The method as in claim 1, wherein forming the thin film shell layer around the conductive nanowires comprises:
forming a precusor solution comprising Na₂SO₄ and KMnO₄; and
immersing the conductive nanowires into the precursor solution.

10. The method as in claim 1, wherien the flexible microwire is a carbon microwire.

11. The method as in claim 1, wherein the flexible microwire has an average diameter of about 5 μm to about 20 μm.

12. A hybrid structure, comprising:
a flexible microfiber defining a surface;
a plurality of conductive nanowires extending radially from the surface of the flexible microfiber, wherein the conductive nanowires comprise a metal oxide; and
a thin film shell layer surrounding each conductive nanowire, wherein the thin film shell layer comprises a transition metal oxide.

13. The hybrid structure as in claim 12, wherein the transition metal oxide comprises MnO₂.

14. The hybrid structure as in claim 12, wherein the metal oxide comprises Zn₂SnO₄, ZnO, SnO₂, In₂O₃, indium tin oxide, or combinations thereof.

15. The hybrid structure as in claim 12, wherein the metal oxide comprises Zn₂SnO₄.

16. The hybrid structure as in claim 12, further comprising:
a catalyst coating layer on the surface of the carbon microfiber.

17. The hybrid structure as in claim 16, wherein the catalyst coating layer comprises gold.

18. The hybrid structure as in claim 12, wherein the conductive nanowires have an average diameter of about 10 nm to about 100 nm.

19. The hybrid structure as in claim 12, wherein the thin film shell layer has an average thickness of about 1 nm to about 20 mn.

20. The hybrid structure as in claim 12, wherien the flexible microwire is a carbon microwire.
